(19) United States
(12) Patent Application Publication
(10) Pub. No.: US 2006/0202807 A1
(43) Pub. Date: Sep. 14, 2006

(54) Vibration induction type alarm

(76) Inventor: Mike Chen, Irvine, CA (US)

Correspondence Address: MIKE CHEN;9F., No. 37, Dongsing Road, Xinyi District, Taipei City, 110, TW

(21) Appl. No.: 11/067,000

(22) Filed: Feb. 28, 2005

(51) Int. Cl. H04B 3/36; G08B 3/00; G08B 5/22

(52) U.S. Cl. 340/407.1; 340/691.1; 340/7.6

(57) ABSTRACT

A vibration induction type alarm includes a carabiner and a body, and the carabiner is connected to the body by a first connector, and the first connector can activate a buzzer installed on the body. The carabiner includes a gate and a movable member installed at the gate. The body includes an upper casing and a lower casing, and the upper casing on its surface has a speaker cover and a plurality of press buttons. The lower casing includes a circuit board, a battery, a buzzer, an induction vibrator, a press button set, and a second connector; wherein the circuit board is electrically connected to the battery, buzzer, induction vibrator, press button set, first connector and second connector, so that the alarm can be activated manually to protect personal safety and has a function of detecting whether or not a personal belonging is moved or stolen.

### FIELD OF THE INVENTION

The present invention relates to a portable alarm, and more particularly to a vibration induction type alarm having an easy accessible carabiner design that is portable and convenient for outdoor uses, and the invention not only can be triggered manually, but also can detect whether a still object is being moved.

### BACKGROUND OF THE INVENTION

In general, a conventional alarm is comprised of a housing, a circuit means and a pull cord means. If a user needs help in a crisis, the user can pull the pull cord means to remove a switch lock tab inserted in the housing to activate the circuit means installed in the housing. A battery installed in the circuit means supplies electric power for the circuit board and a siren speaker in order to scare away evildoers.

For conventional alarms, a user can pull the pull cord means to electrically connect the alarm and start the siren. It means that the alarm is in a passive state and inseparable from the user. The conventional alarms have limited functions and cannot actively detect whether or not an object is stolen. In addition, the pull cord means and the body of a conventional alarm are not connected with each other, so that when the pull cord means is pulled out from the body of the alarm in an emergency case, the pull cord means is usually thrown away by accident or missing. It is a pity and a waste to use an alarm for one time only.

Further, when people have outdoor activities such as camping, mountain climbing, hiking, or swimming, their personal belongings are usually put aside to facilitate their sightseeing, rest and appreciating beautiful sceneries. Since there is a distance between users and their personal belongings, therefore users can have a peace of mind if the alarm has a function of detecting thefts of their personal belongings. Users need not worry about whether or not their personal belongings are still in the original position. In addition, the alarm also can serve as a survival tool for calling for help when the user gets lost or has an accident.

In summation of the description above, the present common alarm always usually goes with the user and rarely comes with a portable function for the surveillance and protection of personal belongings, and thus the inventor of the present invention focused on the trend of modern people being fond of outdoor activities to design a convenient portable alarm for the surveillance and protection of the user's valuables, and protect the user's personal safety.

### SUMMARY OF THE INVENTION

In view of the shortcomings of the conventional prior alarms, the inventor of the present invention based on years of experience of the related industry and conducted extensive researches to overcome the deficiencies and finally invented an alarm capable of being triggered manually to protect personal safety as well as detecting whether or not personal belongings are being stolen.

Therefore, it is a primary objective of the present invention to provide an alarm which is convenient to use, easily accessible, and can be used repeatedly. The alarm can be triggered manually, or configured to alert the condition when an object is being moved or taken away.

To achieve the foregoing objective, the vibration induction type alarm in accordance with the present invention comprises a carabiner and a body, wherein the body includes an upper casing and a lower casing, and the carabiner includes an openable/closable gate, and the carabiner is connected to the body by a first connector, and the first connector can activate a buzzer installed on the body.

The upper casing on its surface has a speaker cover and a plurality of press buttons. The lower casing includes a circuit board, a battery, a buzzer for transmitting sound from the speaker cover, an induction vibrator for activating the buzzer, a press button set corresponding to the plurality of press buttons at the upper casing, a second connector coupled to the first connector; wherein the circuit board is electrically connected to the battery, buzzer, induction vibrator, press button set, first connector and second connector, so that the alarm can be activated manually to protect personal safety and has a function of detecting whether or not personal belonging is moved or stolen.

### BRIEF DESCRIPTION OF THE DRAWINGS

FIG. 1 is an exploded view of the structure of the present invention;

FIG. 2 is an assembly view of the structure of the present invention;

FIG. 3 is a view of the first preferred embodiment of the present invention;

FIG. 4 is a view of the second preferred embodiment of the present invention; and

FIG. 5 is a schematic view of an alarm being triggered according to the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

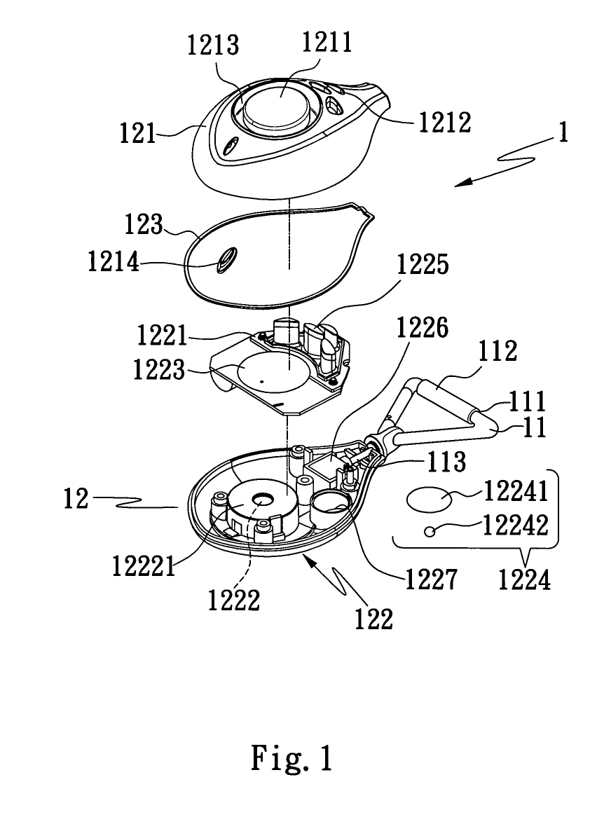

Referring to FIG. 1, an exploded view of the structure in accordance with the present invention is shown. In FIG. 1, a vibration induction type alarm 1 comprises a carabiner 11 and a body 12, and the carabiner 11 further comprises an openable/closable gate 11, a movable member 112 disposed at the gate 111, and the movable member 112 and the carabiner 11 are coupled by a screw nut (or connected by a compressible spring bracket). The movable member 112 is designed to allow users to buckle the alarm easily onto the trousers rings at the waist or the zipper of a backpack. The carabiner 11 is connected to the body 12 by a first connector 113, and the first connector 113 is a plug, such that when the plug is pulled out from the body 11, the vibration induction type alarm is triggered. The carabiner 11 has a triangular metal design (which could be in other geometric shapes including rhombic, rectangular, circular, elliptical, semicircular, heart and U shapes) to make its grip and hold easier for users.

The body 12 further comprises an upper casing 121 and a lower casing 122, and a waterproof washer 123 is installed at the lower casing for preventing failures of the vibration induction type alarm 1 caused by rainwater or sweat falling into the vibration induction type.

The upper casing 21 has a speaker cover 1211 at its surface, and a groove 1213 under the speaker cover 1211 for connecting the interior of the body 12, so that the siren can be transmitted from the speaker cover 1211. The upper casing 21 at its surface further has four press buttons 1212 and a light emitting diode (LED) lamp 1214, and the press buttons 1212 can be set with a password and have the functions of setting or releasing an alarm status and indicating a low battery condition. A blinking LED lamp 1214 indicates the current status of the vibration induction type alarm 1.

The lower casing 122 comprises a circuit board 1221, and the circuit board 1221 further includes an alarm integrated circuit IC for recording user's preferred sound of help such as “Stop it.”, “Hold still.”, and “Fire!”, etc, and a battery 1222 installed in a battery compartment 12221; a buzzer 1223 is provided for transmitting a sound from the speaker cover 1211; an induction vibrator 1224, and the induction vibrator 1224 is comprised of a sensor plate 12241 and a sphere 12242, and the sphere 12242 is disposed into a groove 1227; a sensor plate 12241 covered onto the groove 1227, such that if the vibration induction type alarm 1 is set to detect whether or not an object is being moved and the vibration of the sphere 12242 of the induction vibrator 1224 is detected, then the sensor plate 12241 will be tapped to activate the buzzer 1224 to produce an alarm (the induction vibrator 1224 could be made of a mercury level, such that if the vibration induction type alarm 1 is set to detect whether or not an object is being moved and the vibration of the mercury level of the induction vibrator 1224 is detected, then the sensor plate 12241 will be tapped to activate the buzzer 1224 to scare away evildoers.

Furthermore, the lower casing 122 includes a press button set 1225 corresponding to the plurality of press buttons 1212 of the upper casing 121, and the lower casing 122 further includes a second connector 1226 such as a socket for receiving the plug of the first connector 113.

The circuit board 1221 is electrically connected with the battery 122, buzzer 1223, induction vibrator 1224, press button set 1225, second connector 1226, and first connector 113. The alarm includes a warning and delay circuit design to warn thefts and evildoers and allows anyone to enter a password within a preset time to release the alarm.

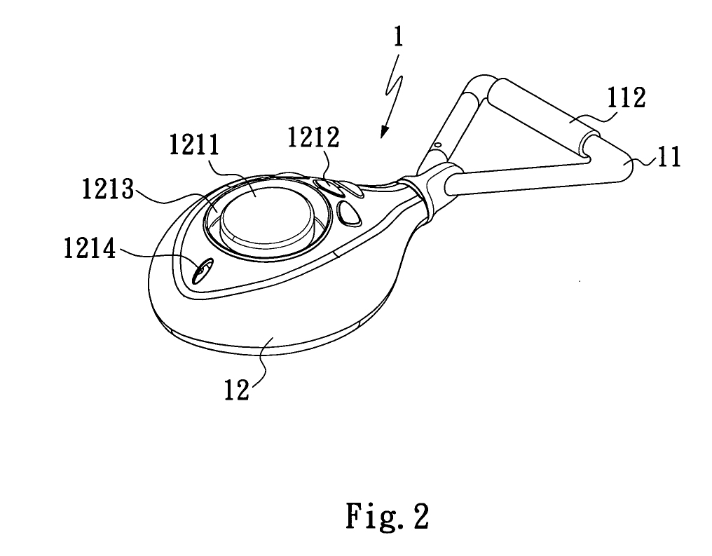

Referring to FIG. 2, an assembly view of the structure of the present invention is illustrated. In FIG. 2, the vibration induction type alarm 1 is comprised of a carabiner 11 and a body 12, and the first connector 113 and second connectors 1226 connect the carabiner 11 and the body 12 as shown in FIG. 1. The movable member 112 of the carabiner 11 can be hanged on a user's body to facilitate user's pulling, or hanged onto an object so as to detect whether or not the object is being taking away or stolen. The body 12 at its surface includes four press buttons 1212 for user's configuration. The speaker cover 1211 is installed in a groove 1213, and the groove 1213 is interconnected to the interior of the body 12. A blinking LED lamp 1214 indicates the current status of the vibration induction type alarm 1.

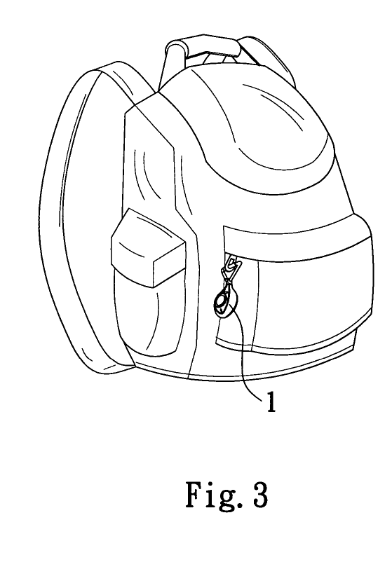

Referring to FIG. 3, a preferred embodiment of the present invention is illustrated. In FIG. 3, a vibration induction type alarm 1 is hanged onto a zipper of a backpack, which is very convenient since users do not have to hold the alarm 1 by hands. If a user temporarily stores the backpack at a certain place, the user just needs to set up the vibration induction type alarm 1, and the vibration induction type alarm 1 will automatically detect whether or not the backpack is moved. If the backpack has been taken away, the siren of the vibration induction type alarm 1 will sound to scare away the thief and remind the user to take proper actions.

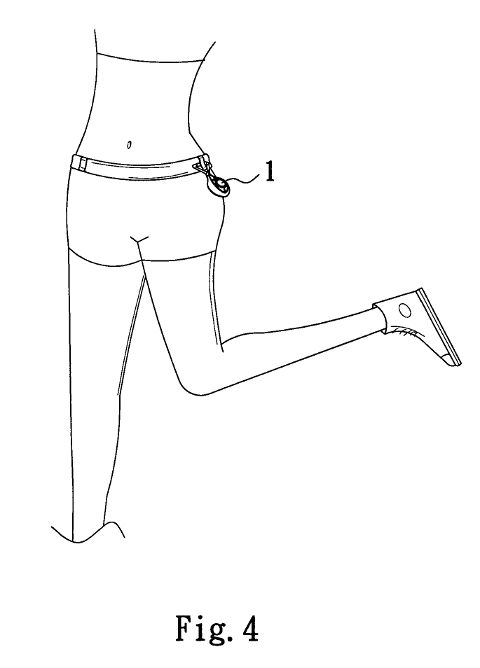

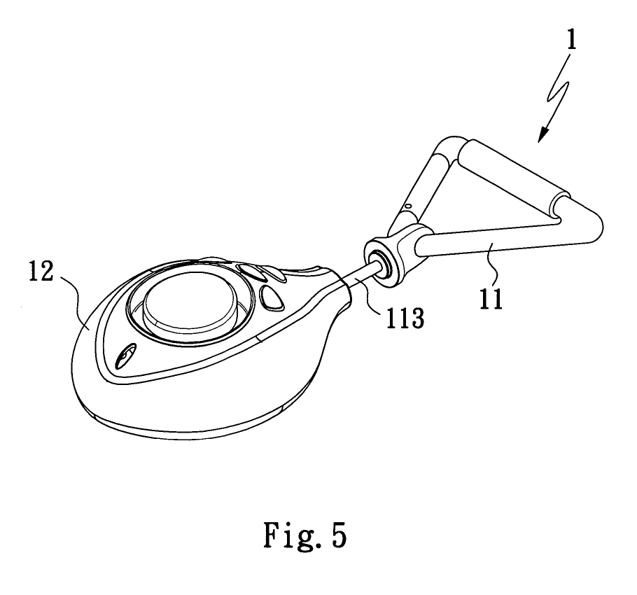

Referring to FIGS. 4 and 5, a schematic view of another preferred embodiment of the present invention and a schematic view of triggering the alarm are illustrated. In the figures, the vibration induction type alarm 1 can be hanged onto a waist belt, not only convenient for its user, but also gives an artistic look. When a thief is approaching, the user can pull the body 12 out downwardly, the first connector 113 is detached slightly from the body 12 (as shown in FIG. 5) to trigger the siren of the vibration induction type alarm 1 and bring the attention of people around for help. When the siren is activated, the first connector 113 is pulled outward from the body 12 but still in contact with the body 12. After the crisis is over, the first connector 113 is pushed back into the body again to get ready for the next use. Therefore, such alarm can be used repeatedly for many times to save costs.

With the structural design of the present invention, the alarm not only can be triggered manually, but also can achieve the effect of automatically triggering the alarm.

In summation of the description above, the vibration induction type alarm of the present invention is novel and useful and definite enhances the performance over the conventional structure and further complies with the patent application requirements and is submitted to the Patent and Trademark Office for review and granting of the commensurate patent rights.

What is claimed is:

1. A vibration induction type alarm, comprising a carabiner and a body, wherein said body has an upper casing and a lower casing;
said carabiner has a gate and is connected to said body by a first connector, and said first connector can start a buzzer installed in said body;
said upper casing at its surface has a speaker cover and a plurality of press buttons;
said lower casing has a circuit board, a battery, and a buzzer for transmitting sound from said speaker cover, an induction vibrator for starting said buzzer, a press button set corresponding to said plurality of press buttons of said upper casing, a second connector coupled with said first connector; wherein said circuit board is electrically coupled with said battery, said buzzer, said induction vibration, said press button set, said first connector, and said second connector.

2. The vibration induction type alarm of claim 1, wherein said carabiner is in a geometric shape.

3. The vibration induction type alarm of claim 1, wherein said carabiner installs a movable member at said gate, and said movable member and said carabiner can be coupled by a method selected from the collection of being secured by a screw nut and by a compressible spring bracket.

4. The vibration induction type alarm of claim 1, wherein said first connector is a plug and said second connector is a socket.

5. The vibration induction type alarm of claim 1, wherein said speaker cover of said upper casing has a groove interconnected to the interior of said body.

6. The vibration induction type alarm of claim 1, wherein said upper casing at its surface has at least one light emitting diode (LED) lamp.

7. The vibration induction type alarm of claim 1, wherein said lower casing has a battery compartment for disposing said battery.

8. The vibration induction type alarm of claim 1, wherein said upper and lower casings have a waterproof washer therebetween.

9. The vibration induction type alarm of claim 1, wherein said circuit board has an alarm integrated circuit (IC).

10. The vibration induction type alarm of claim 1, wherein said induction vibrator comprises a sensor plate and a sphere.

11. The vibration induction type alarm of claim 1, wherein said induction vibrator comprises a mercury level.
